(19) United States
(12) Patent Application Publication
(10) Pub. No.: US 2023/0417890 A1
(43) Pub. Date: Dec. 28, 2023

(54) SYSTEM AND METHOD FOR MEASURING PROXIMITY BETWEEN DEVICES USING ACOUSTICS

(71) Applicant: Samsung Electronics Co., Ltd., Suwon-si (KR)

(72) Inventors: Wenjun Jiang, San Jose, CA (US); Ruofeng Liu, San Jose, CA (US); Xun Chen, Fremont, CA (US)

(21) Appl. No.: 17/931,455

(22) Filed: Sep. 12, 2022

Related U.S. Application Data
(60) Provisional application No. 63/355,971, filed on Jun. 27, 2022.

(51) Int. Cl. G01S 11/14; G01H 3/08

(52) U.S. Cl. CPC G01S 11/14; G01H 3/08; H04B 7/00

(57) ABSTRACT

A method includes emitting a sound by a first device. The method also includes receiving a recorded sound at the first device, where the recorded sound includes a recording of the emitted sound by a second device. The method further includes determining an intermediate frequency (IF) signal based on the emitted sound and the recorded sound. The method also includes determining a distance between the first device and the second device based on a frequency of the IF signal and one or more characteristics of the emitted sound. In addition, the method includes presenting the determined distance.

### CROSS-REFERENCE TO RELATED APPLICATION AND PRIORITY CLAIM

This application claims priority under 35 U.S.C. § 119(e) to U.S. Provisional Patent Application No. 63/355,971 filed on Jun. 27, 2022. This provisional application is hereby incorporated by reference in its entirety.

### TECHNICAL FIELD

This disclosure relates generally to wireless systems. More specifically, this disclosure relates to a system and method for measuring proximity between devices using acoustics.

### BACKGROUND

Along with the rapid growth of Internet-of-Things (IoT), more and more applications have started to leverage the capabilities of heterogeneous devices to create new and immersive experiences. Traditional computing devices (such as desktop and laptop computers) and newer intelligent computing devices (such as smartphones, tablets, and wearables like smart watches and earbuds) are being connected together in collaborative ways to enable new services that previously were not possible. At the same time, with increasing focus on privacy issues (and sometimes on cloud dependency and cost), device-to-device communication and collaboration has become an important topic. Distance awareness (such as knowledge of the physical distance between devices, sometimes referred to as proximity awareness) is an important consideration to facilitate device-to-device communication and collaboration.

### SUMMARY

This disclosure provides a system and method for measuring proximity between devices using acoustics.

In a first embodiment, a method includes emitting a sound by a first device. The method also includes receiving a recorded sound at the first device, where the recorded sound includes a recording of the emitted sound by a second device. The method further includes determining an intermediate frequency (IF) signal based on the emitted sound and the recorded sound. The method also includes determining a distance between the first device and the second device based on a frequency of the IF signal and one or more characteristics of the emitted sound. In addition, the method includes presenting the determined distance.

In a second embodiment, an electronic device includes at least one processing device configured to control the electronic device to emit a sound. The at least one processing device is also configured to receive a recorded sound, where the recorded sound includes a recording of the emitted sound by a second device. The at least one processing device is further configured to determine an IF signal based on the emitted sound and the recorded sound. The at least one processing device is also configured to determine a distance between the electronic device and the second device based on a frequency of the IF signal and one or more characteristics of the emitted sound. The electronic device also includes at least one display configured to show the determined distance.

In a third embodiment, a non-transitory machine-readable medium contains instructions that when executed cause at least one processor of an electronic device to control the electronic device to emit a sound. The medium also contains instructions that when executed cause the at least one processor to receive a recorded sound, where the recorded sound includes a recording of the emitted sound by a second device. The medium further contains instructions that when executed cause the at least one processor to determine an IF signal based on the emitted sound and the recorded sound. The medium also contains instructions that when executed cause the at least one processor to determine a distance between the electronic device and the second device based on a frequency of the IF signal and one or more characteristics of the emitted sound. In addition, the medium contains instructions that when executed cause the at least one processor to control at least one display to show the determined distance.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a drier, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration including an electronic device according to this disclosure;

FIG. 2 illustrates an example system and an example technique for measuring proximity between devices using acoustics according to this disclosure;

FIG. 3 illustrates another example technique for measuring proximity between devices using acoustics in the system of FIG. 2 according to this disclosure;

FIG. 4 illustrates an example process for measuring proximity between devices using acoustics according to this disclosure;

FIG. 5 illustrates an example framework for measuring proximity between devices using acoustics according to this disclosure;

FIG. 6 illustrates an example acoustic ranging algorithm according to this disclosure;

FIG. 7 illustrates an example quantitative chirp duration adjustment according to this disclosure;

FIG. 8 illustrates an example quantitative chirp number adjustment according to this disclosure; and

FIG. 9 illustrates an example method for measuring proximity between devices using acoustics according to this disclosure.

### DETAILED DESCRIPTION

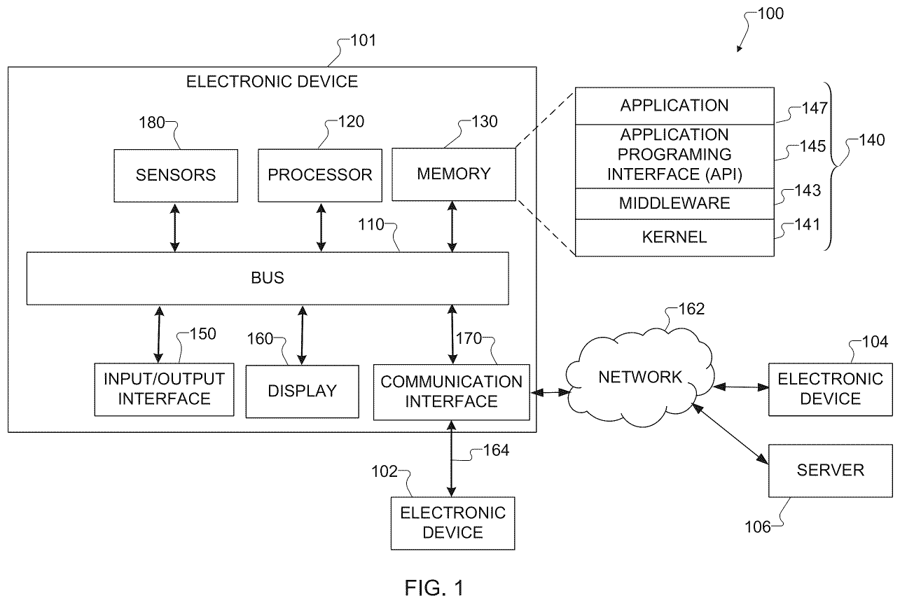

FIGS. 1 through 9, discussed below, and the various embodiments of this disclosure are described with reference to the accompanying drawings. However, it should be appreciated that this disclosure is not limited to these embodiments and all changes and/or equivalents or replacements thereto also belong to the scope of this disclosure.

As discussed above, more and more applications have started to leverage the capabilities of heterogeneous devices to create new and immersive experiences. Traditional computing devices (such as desktop and laptop computers) and newer intelligent computing devices (such as smartphones, tablets, and wearables like smart watches and earbuds) are being connected together in collaborative ways to enable new services that previously were not possible. At the same time, with increasing focus on privacy issues (and sometimes on cloud dependency and cost), device-to-device communication and collaboration has become an important topic. Distance awareness (such as knowledge of the physical distance between devices, sometimes referred to as proximity awareness) is an important consideration to facilitate device-to-device communication and collaboration.

Typically, for wireless-enabled devices, the distance between two devices can be “sensed” (such as estimated) using one or more wireless interfaces, such as WiFi, Bluetooth, and ultra-wideband (UWB) interfaces. However, on many conventional devices currently available, distance measurement using WiFi and Bluetooth is based on wireless signal strength measurements, which typically fluctuate and are vulnerable to noise. Therefore, the corresponding distance measurements may not be accurate. Conversely, while UWB has greater accuracy in distance measurement than WiFi or Bluetooth, UWB is not available in many devices.

Acoustic sensing, which uses one or more speakers and microphones, is an emerging technology for sensing the distance between devices. Acoustic sensing has attracted much attention as it usually offers better accuracy than WiFi or Bluetooth and can be performed using only one or more microphones and one or more speakers that are already widely available on most modern computing devices. In most traditional acoustic sensing frameworks, the speaker(s) and microphone(s) either belong to the same mobile device (such as onboard speaker(s) and microphone(s) of a smartphone) or belong to two peer mobile devices (such as two smartphones). However, the former makes it difficult to measure relatively long ranges (such as several meters) because the speaker(s) and the microphone(s) cannot be placed apart by a suitable distance. The latter offers flexibility in the placement of the speaker(s) and the microphone(s), but it is not very compatible with the scenario of a single user because a single user usually owns only one of the same type of mobile device.

This disclosure provides various techniques for measuring proximity between devices using acoustics. As described in more detail below, the disclosed systems and methods play one or more sounds from at least one speaker and record the sound(s) using at least one microphone. In some embodiments, the speaker and the microphone can belong to a mobile device and an acoustic device, respectively. In other embodiments, the speaker and the microphone can belong to the acoustic device and the mobile device, respectively. In both modes, the mobile device and the acoustic device can be connected via a radio-frequency (RF) module (such as Bluetooth, WiFi, UWB, etc.) to transmit audio data. Moreover, the disclosed systems and methods provide multiple approaches for automatically detecting ambient noise and improving signal-to-noise ratio (SNR) to an appropriate level at the cost of just a small amount of delay. This enables the disclosed embodiments to self-adapt to various environments having different levels of noise.

In recent times, increasing numbers of individuals own increasingly rich wireless devices (such as smart watch, earbuds, smart speakers, and the like) that have at least one on-board speaker and at least one microphone. Often, multiple devices (such as a smartphone and N wireless acoustic devices like earbuds, a smart watch, a smart speaker, etc.) are used together by one individual as a connected system. Accordingly, some embodiments of this disclosure use such connected system devices for proximity measurement.

Compared to prior techniques, the disclosed embodiments are robust enough to improve acoustic proximity measurement in various physical configurations. In addition, the disclosed embodiments perform successfully when exposed to environments having different level of noise. This makes these embodiments ideal for real-world applications, such as detecting nearby devices, avoiding circumstances of forgetting devices, and practicing social distancing.

Note that while some of the embodiments discussed below are described in the context of use in consumer electronic devices (such as smartphones), this is merely one example. It will be understood that the principles of this disclosure may be implemented in any number of other suitable contexts and may use any suitable devices.

FIG. 1 illustrates an example network configuration 100 including an electronic device according to this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more of a central processing unit (CPU), an application processor (AP), or a communication processor (CP). The processor 120 is able to perform control on at least one of the other components of the electronic device 101 and/or perform an operation or data processing relating to communication. In some embodiments, the processor 120 can be a graphics processor unit (GPU). As described in more detail below, the processor 120 may perform one or more operations for measuring proximity between devices using acoustics.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support one or more functions for measuring proximity between devices using acoustics as discussed below. These functions can be performed by a single application or by multiple applications that each carry out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a cellular communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 include one or more cameras or other imaging sensors for capturing images of scenes. The sensor(s) 180 can also include one or more buttons for touch input, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

The first external electronic device 102 or the second external electronic device 104 can be a wearable device or an electronic device-mountable wearable device (such as an HMD). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, that include one or more imaging sensors.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described in more detail below, the server 106 may perform one or more operations to support techniques for measuring proximity between devices using acoustics.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

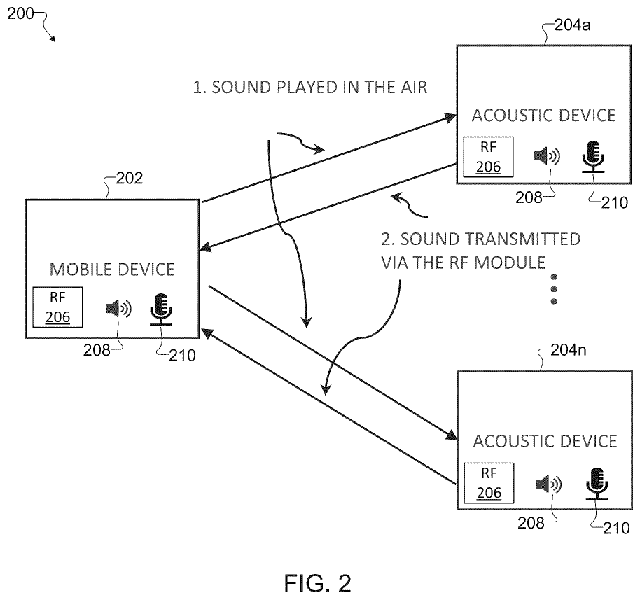

FIG. 2 illustrates an example system 200 and an example technique for measuring proximity between devices using acoustics according to this disclosure. For ease of explanation, the system 200 is described as being implemented using one or more components of the network configuration 100 of FIG. 1 described above, such as the electronic devices 101, 102, and 104. However, this is merely one example, and the system 200 could be implemented using any other suitable device(s) and in any other suitable system(s).

As shown in FIG. 2, the system 200 includes a mobile device 202 and multiple acoustic devices 204a-204n. The mobile device 202 can represent (or be represented by) the electronic device 101 of FIG. 1. In some embodiments, the mobile device 202 is a smartphone, tablet, or the like. The acoustic devices 204a-204n represent devices that are capable of generating and emitting sound, such as earbuds or smart speakers. The acoustic devices 204a-204n can represent (or be represented by) others of the electronic devices of FIG. 1, such as the electronic devices 102 and 104. While FIG. 2 is shown with multiple (N>1) acoustic devices 204a-204n, some embodiments may include only one acoustic device (N=1).

The mobile device 202 is relatively proximate to each of the acoustic devices 204a-204n. For example, the distance between the mobile device 202 and each of the acoustic devices 204a-204n can be as little as 5 mm or less or as large as a few meters or more. In particular, the distance between the mobile device 202 and each of the acoustic devices 204a-204n can be small enough that sound emitted from one of the devices 202, 204a-204n can be detected at other ones of the devices 202, 204a-204n. Each of the mobile device 202 and the acoustic devices 204a-204n can include an RF module 206 (which can represent or be represented by the communication interface 170 of FIG. 1), one or more speakers 208, and one or more microphones 210.

In FIG. 2, a first technique for measuring proximity between devices using acoustics and the system 200 is shown. In the first technique, the mobile device 202 emits one or more sounds, such as from the speaker 208. In some embodiments, the sounds include one or more frequency-modulated continuous-wave (FMCW) chirps. The sounds are conveyed through the air as sound waves and are received at one or more of the acoustic devices 204a-204n, such as by one or more microphones 210 of each acoustic device 204a-204n. Each acoustic device 204a-204n records the sounds, and one or more of the acoustic devices 204a-204n wirelessly transmits the recorded sounds back to the mobile device 202 as sound data via the RF module 206. After the mobile device 202 receives the recorded sound data from the acoustic device(s) 204a-204n, the mobile device 202 determines one or more intermediate frequency (IF) signals based on the emitted sounds and the recorded sound data. The mobile device 202 can also determine a distance between the mobile device 202 and one or more of the acoustic devices 204a-204n using the frequency of the IF signal(s) and one or more characteristics of the emitted sounds (such as the duration and bandwidth of the FMCW chirps, etc.). Further details of the determination of IF frequency signals and distances are provided below. The determined distance can be presented to a user, such as by showing the distance on a display of the mobile device 202 (like on the display 160).

By receiving recorded sound data from each of the acoustic devices 204a-204n, the mobile device 202 can simultaneously or sequentially calculate a distance to each of N acoustic devices 204a-204n. In some embodiments, the system 200 can used this distance measurement technique to track the movement of the mobile device 202 relative to each acoustic device(s) 204a-204n and provide one or more location-aware services. For example, if two or more of the acoustic devices 204a-204n are televisions, the system 200 can be used to determine the television closest to the mobile device 202 in preparation for streaming a video from the mobile device 202 to the closest television.

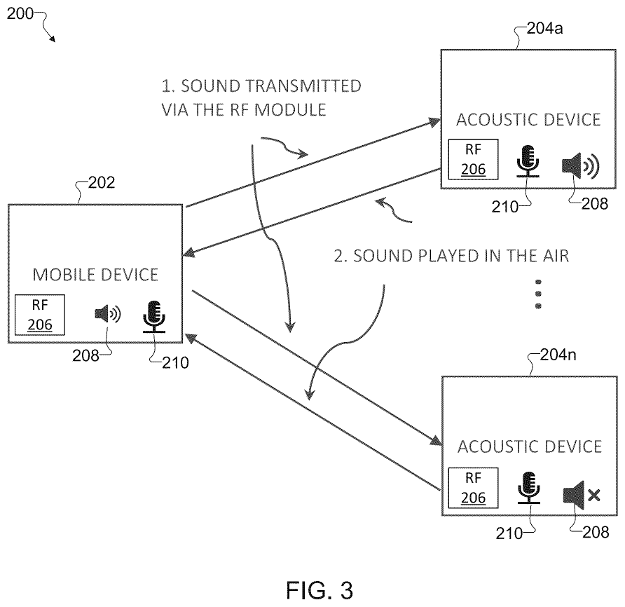

FIG. 3 illustrates another example technique for measuring proximity between devices using acoustics in the system 200 of FIG. 2 according to this disclosure. In this technique, the acoustic devices 204a-204n are used as the sound emitters, and the mobile device 202 is used as the sound receiver. As shown in FIG. 3, the mobile device 202 wirelessly transmits, via the RF module 206, sound data to the acoustic devices 204a-204n. The transmitted sound data represents N-channel sounds for the N acoustic devices 204a-204n to play. In some embodiments, the N-channel sounds include FMCW chirps on only one channel (such as FMCW chirps to be emitted by only one of the acoustic devices 204a-204n), where the other channels are muted to avoid interference of the sound. The sounds from the unmuted acoustic device 204a-204n are conveyed through the air as sound waves and are received at the mobile device 202, such as by the microphone 210. The mobile device 202 records the sounds and determines one or more IF signals based on the sound data transmitted by the mobile device 202 and the recorded sounds received by the mobile device 202. The mobile device 202 can also determine a distance between the mobile device 202 and the acoustic device 204a-204n that emitted the sounds using the frequency of the IF signal(s) and one or more characteristics of the recorded sounds (such as the duration and bandwidth of the FMCW chirps, etc.).

The distance measurement technique can be repeated in another round, with the mobile device 202 transmitting sound data with a different active channel of the N-channel sounds for a different acoustic device 204a-204n to play. The distance measurement technique can be repeated for N rounds until each of the acoustic devices 204a-204n has emitted FMCW chirps. Similar to the technique described in FIG. 2, the technique of FIG. 3 can be used to track the movement of the mobile device 202 and provide location-aware services, such as streaming a video from the mobile device 202 to the closest television.

Although FIGS. 2 and 3 illustrate one example of a system 200 and various examples of techniques for measuring proximity between devices using acoustics, various changes may be made to FIGS. 2 and 3. For example, the system 200 could include any number of each component in any suitable arrangement. In general, computing and communication systems come in a wide variety of configurations, and FIGS. 2 and 3 do not limit the scope of this disclosure to any particular configuration. Also, while described as involving a specific sequence of operations, various operations of the techniques described with respect to FIGS. 2 and 3 could overlap, occur in parallel, occur in a different order, or occur any number of times (including zero times). In addition, the specific operations shown in FIGS. 2 and 3 are examples only, and other techniques could be used to perform each of the operations shown in FIGS. 2 and 3.

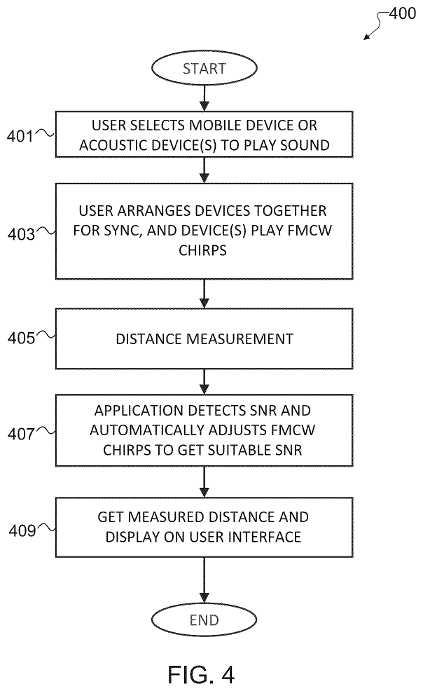

FIG. 4 illustrates an example process 400 for measuring proximity between devices using acoustics according to this disclosure. For ease of explanation, the process 400 shown in FIG. 4 is described as involving the use of the system 200 shown in FIGS. 2 and 3. However, the process 400 shown in FIG. 4 could be used with any other suitable device(s) and in any other suitable system(s)

As shown in FIG. 4, a user (such as a user of the mobile device 202 and the acoustic devices 204a-204n) selects either the mobile device 202 or the acoustic devices 204a-204n to be a sound player in operation 401. This can include, for example, the user making a device selection on a graphical user interface (GUI) of the mobile device 202. This selection determines which of the proximity measurement techniques described in FIGS. 2 and 3 will be used for distance measurement. The user arranges the mobile device 202 and the acoustic devices 204a-204n together in physical proximity in operation 403. Based on the user selection, either the mobile device 202 or the acoustic devices 204a-204n play one or more sounds (such as FMCW chirps) as part of one of the proximity measurement techniques described earlier.

The user can initiate measurement of the distance between the mobile device 202 and the acoustic devices 204a-204n in operation 405 using one of the proximity measurement techniques described earlier. This can include, for example, the user moving one or more of the mobile device 202 or the acoustic devices 204a-204n to determine different distances or achieve a desired distance. The proximity measurement technique can automatically adapt to different levels of environmental noise in operation 407 using an adaptive control algorithm. Multiple adaptive control algorithms are described in greater detail below. After adequate FMCW chirps are received, the mobile device 202 can obtain the measured distance and show the distance on the GUI display of the mobile device 202 in operation 409.

Although FIG. 4 illustrates one example of a process 400 for measuring proximity between devices using acoustics, various changes may be made to FIG. 4. For example, while shown as a series of steps, various steps in FIG. 4 could overlap, occur in parallel, occur in a different order, or occur any number of times.

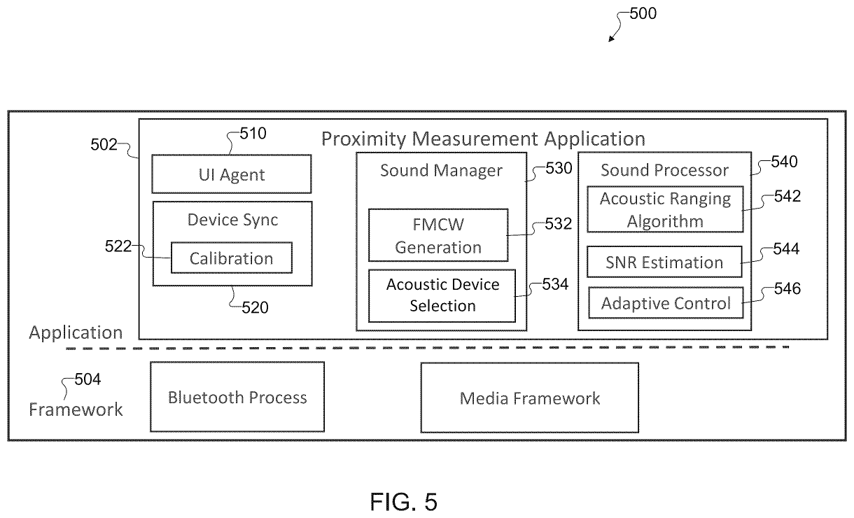

FIG. 5 illustrates an example framework 500 for measuring proximity between devices using acoustics according to this disclosure. For ease of explanation, the framework 500 is described as being implemented in the mobile device 202 to perform the process 400 described above. However, this is merely one example, and the framework 500 could be implemented using any other suitable process(es) and device(s) and in any other suitable system(s).

As shown in FIG. 5, the framework 500 includes a proximity measurement application 502 and an operating system (OS) framework 504. The proximity measurement application 502 is a user-facing application that implements many of the functions of the proximity measurement process 400. Such functions include synchronizing the mobile device 202 and the acoustic devices 204a-204n, initiating and controlling a user interface (UI) agent 510, executing a device synchronization module 520, creating and executing a sound manager 530, and creating and executing a sound processor 540.

The OS framework 504 operates at the OS level of the mobile device 202 to facilitate the execution of the proximity measurement application 502 in the mobile device 202. The OS framework 504 leverages at least one audio module (such as the speaker 208 and the microphone 210) and at least one communication module (such as the RF module 206) of the mobile device 202 to implement sound transmitting, receiving, and playing. The OS framework 504 includes any suitable software, firmware, hardware, or combination of these to facilitate execution of a user-facing application and communication with other devices, such as the acoustic devices 204a-204n. In some embodiments, the OS framework may be an ANDROID framework. However, other suitable OS types are possible and within the scope of this disclosure.

The UI agent 510 represents a GUI for showing distance information from the proximity measurement application 502 and interacting with the user. In some embodiments, the user uses the UI agent 510 to initiate or stop synchronization of the mobile device 202 and the acoustic devices 204a-204n, indicate which of the mobile device 202 and the acoustic devices 204a-204n will play a sound, and initiate or stop the proximity measurement process 400. The UI agent 510 can show the process of synchronization/measurement and the measured distance on a display of the mobile device 202. The UI agent 510 can include any additional or alternative functions for interacting with the user.

The device synchronization module 520 can be used as needed to synchronize the mobile device 202 and the acoustic devices 204a-204n. As is typical for electronic devices, the mobile device 202 and the acoustic devices 204a-204n can each have its own clock. Over time, the clocks may slowly become out of sync, which is often referred to as clock drift. To ensure that the process 400 performs as accurately as possible, the mobile device 202 can use the device synchronization module 520 to eliminate the clock drift and avoid cumulative distance measurement error.

The device synchronization module 520 supports any suitable process for reducing or eliminating clock drift between devices. In some embodiments, the device synchronization module 520 supports a calibration process 522 that can be performed before distance measurement. During the calibration process 522, the proximity measurement application 502 instructs the user to place the mobile device 202 and the acoustic devices 204a-204n in proximity to each other. The proximity measurement application 502 collects FMCW chirps from the acoustic devices 204a-204n, which are used for calibration. In some embodiments, the steps of the calibration process 522 are shown on the UI agent 510.

The sound manager 530 includes an FMCW generation module 532, which generates the FMCW chirp data. The sound manager 530 also includes an acoustic device selection module 534, which selects which acoustic device 204a-204n is to be unmuted (if needed) before playing a sound (such as is described in FIG. 3). In some embodiments, the bandwidth of the FMCW chirps is fixed (such as from 1 kHz to 7 kHz), but the FMCW generation module 532 can adjust the duration and number of the chirps according to feedback from an adaptive control module 546 (described below). The generated FMCW chirps can be played by the speaker 208 of the mobile device 202, recorded by the microphone 210 on the acoustic devices 204a-204n, and transmitted back to the mobile device 202 (via the RF module 206) for processing (such as described in FIG. 2). Alternatively, the generated FMCW chirps can be transmitted to and played by one or more acoustic devices 204a-204n, which can be recorded and processed by the mobile device 202 (such as described in FIG. 3). In some embodiments, the sound manager 530 is started and stopped by the UI agent 510. Additionally or alternatively, the sound manager 530 can call the sound processor 540 to process the FMCW sounds.

The sound processor 540 processes the FMCW sounds recorded by the microphone 210 or emitted by the speaker 208 in order to perform acoustic ranging. Here, acoustic ranging is synonymous with proximity measurement and refers to estimating the distance between the mobile device 202 and one or more of the acoustic devices 204a-204n. The sound processor 540 also receives and processes clock drift information from the device synchronization module 520 for synchronization of the mobile device 202 and the acoustic devices 204a-204n. In this example, the sound processor 540 includes an acoustic ranging algorithm 542, an SNR estimation module 544, and the adaptive control module 546.

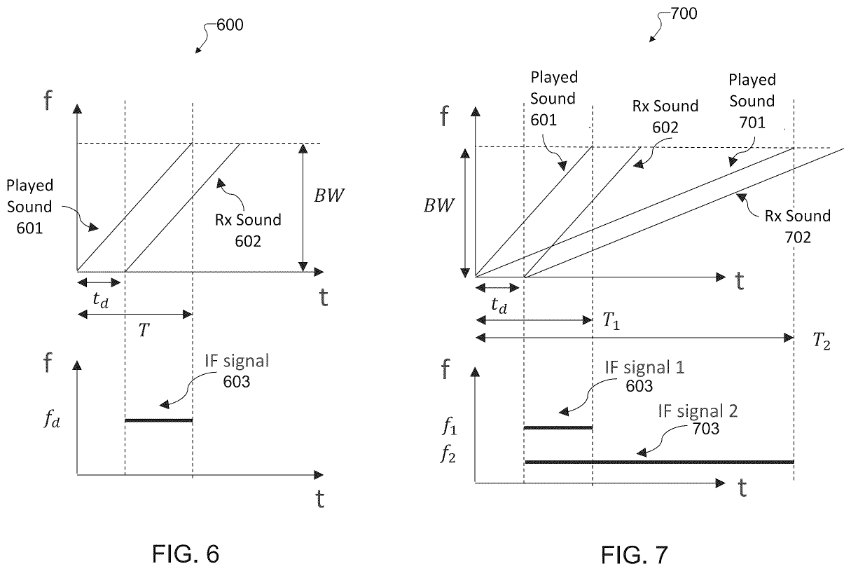

FIG. 6 illustrates an example acoustic ranging algorithm 542 according to this disclosure. As shown in FIG. 6, the acoustic ranging algorithm 542 can be a ranging fast Fourier transform (FFT) algorithm. In a chart 600, the horizontal axis represents time, and the vertical axis represents frequency. It is assumed, for the sake of simplicity, that there is zero noise.

At time “0,” a played sound 601 is emitted, such as by the speaker 208 of the mobile device 202. The played sound 601 represents a sound that can include FMCW chirps as described above. The played sound 601 has a duration of T and changes (such as increases) in frequency over time. The frequency bandwidth of the played sound 601 is denoted as “BW.” Both T and BW can be constant for a fixed set of FMCW chirps. The played sound 601 is received at another device, such as by the microphone 210 at one of the acoustic devices 204a-204n, as a received (Rx) sound 602. Due to the speed of sound and the distance between the mobile device 202 and the acoustic device 204a-204n, the sound 602 is delayed from the played sound 601 by time t_{d}.

Using the FFT algorithm, the sound processor 540 mixes the Rx sound 602 with the played sound 601 to produce an IF signal 603, whose frequency is the difference between the instantaneous frequencies of the played sound 601 and the Rx sound 602. If there is a constant distance between the mobile device 202 and the acoustic device 204a-204n, the two signals 601-602 result in an IF signal 603 of constant frequency tone f_{d}. Using the frequency tone f_{d} of the IF signal 603, the sound processor 540 can determine the range (such as distance) between the mobile device 202 and the acoustic device 204a-204n. In some embodiments, the distance d can be calculated according to the following.

$$d = {t}_{d} \times {V}_{s} = {f}_{d} \times \frac{T}{B W} \times {V}_{s}$$

Here, Vₛ is the speed of sound.

The SNR estimation module 544 can perform SNR estimation in the frequency domain in order to reduce SNR in the acoustic ranging algorithm 542. Here, SNR is defined as the ratio of signal power to noise power. In order to calculate SNR, the SNR estimation module 544 can calculate the frequency spectrum of the mixed IF signal 603. Due to the ambient noise around the mobile device 202 and the acoustic device(s) 204a-204n and multi-path effects, the frequency spectrum may have non-zero values on almost all frequency components. When SNR is high, the power of the highest frequency component is more prominent than when SNR is low. Let Yᵣ represent the Fourier transform of the Rx sound 602, S represent the frequency bins of the played sound 601, and N represent the frequency bins of the noise. In some cases, the SNR can be calculated as follows.

$$SNR = 10 {log}_{10} \frac{{P}_{signal}}{{P}_{n o i s e}} = 10 {log}_{10} \frac{{\sum }_{i ∈ S} {\vert {Y}_{r} [ i ] \vert}^{2}}{{\sum }_{i ∈ N} {\vert {Y}_{r} [ i ] \vert}^{2}}$$

The adaptive control module 546 provides control information for use by the FMCW generation module 532 to adjust a duration and/or a number of chirps in the played sound 601. For example, the adaptive control module 546 can use the estimated SNR from the SNR estimation module 544 to provide the control information, which can include instructions for either (1) quantitative chirp duration adjustment or (2) quantitative chirp number adjustment. These two possibilities are now described.

FIG. 7 illustrates an example quantitative chirp duration adjustment according to this disclosure. In quantitative chirp duration adjustment, the chirp duration of a played sound can be increased to improve SNR. Consider that the received signal Xᵣ[n] is composed of the played sound Xₚ[n] and the noise σ[n], as represented by Xᵣ[n]=Xₚ[n]+σ[n]. When the chirp duration increases, the power of the noise (assuming it is Gaussian white noise) will remain unchanged, but the power of the IF signal will increase proportionally.

As shown in FIG. 7, a chart 700 compares the signals 601-603 from FIG. 6 to revised signals 701-703, including a revised played sound 701, a revised Rx sound 702, and a revised IF signal 703. The revised signals 701-703 represent a longer chirp duration over the original signals 601-603. The duration of the original played sound 601 is T₁, and the duration of the revised played sound 701 is T₂, which is longer than T₁. Similarly, the original Rx sound 602 and the revised Rx sound 702 have durations of T₁ and T₂, respectively. If the mobile device 202 and the acoustic device(s) 204a-204n do not move relative to each other, the time delay t_{d} remains a constant.

The original IF signal 603 and the revised IF signal 703 have frequency tones f₁ and f₂ that, for a fixed distance d, can be determined by

$${f}_{1} = {t}_{d} \times \frac{B W}{{T}_{1}} and {f}_{2} = {t}_{d} \times \frac{B W}{{T}_{2}}$$

respectively. When T₁>>t_{d} and T₂>>t_{d}, the original IF signal 603 is approximately a sinusoid of frequency f₁ and duration T₁ in the time domain. Similarly, the revised IF signal 703 is approximately a sinusoid of frequency f₂ and duration T₂ in the time domain. In that case, the power of the original chirp P₁ and the power of the revised chirp P₂ have the relationship

$$\frac{{P}_{1}}{{P}_{2}} \approx \frac{{T}_{1}}{{T}_{2}} .$$

The power of the noise may not change, so the SNR of the original chirp SNR₁ and the SNR of the revised chirp SNR₂ can have the relationship

$${SNR}_{2} - {SNR}_{1} \approx 10 {log}_{10} \frac{{T}_{2}}{{T}_{1}} .$$

This relationship enables the adaptive control module 546 to increase or decrease SNR by increasing or decreasing the chirp duration. For example, to increase SNR by 10 log₁₀ α, the adaptive control module 546 can change the chirp duration from T to αT. The quantitative chirp duration adjustment algorithm enables the framework 500 to trade off a small amount of latency for better ranging accuracy. In most real-world implementations, this is acceptable because distance measurement is typically tolerant of such small delays. Meanwhile, the adjustment is quick because the target chirp duration can be calculated quantitatively and is adjusted only once for a specific distance.

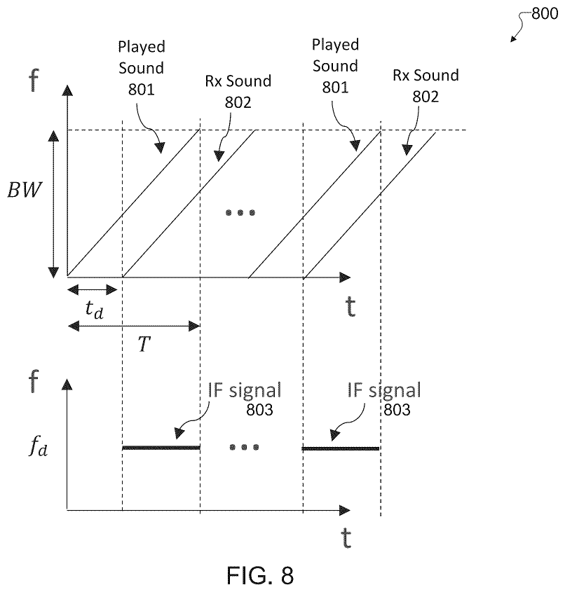

FIG. 8 illustrates an example quantitative chirp number adjustment according to this disclosure. In quantitative chirp number adjustment, the number of played chirps in the played sound can be increased to improve SNR, rather than increasing the duration of the played sound.

As shown in FIG. 8, a chart 800 illustrates that, instead of only one played sound 801 being emitted (such as by the speaker 208 of the mobile device 202), there are multiple (N) played sounds 801 emitted in a sequence. The N played sounds 801 are received as N Rx sounds 802, and N IF signals 803 can be determined as discussed above. When SNR is lower than a predefined threshold, the adaptive control module 546 can stack the range FFT results from the N played sounds 801 into a matrix and perform a doppler FFT. Since the distance to measure does not change significantly during a short period of time, the N played sounds 801 add up constructively, making the power of the resulting signal N times as large as that of one signal. However, the power of the noise does not change. Thus, to increase SNR by at least 10 log₁₀ α, the number of chirps can be increased, such as to at least a times as large as the original number.

Although FIGS. 5 through 8 illustrate one example of a framework 500 for measuring proximity between devices using acoustics and related details, various changes may be made to FIGS. 5 through 8. For example, while the framework 500 is described with various examples of modules, algorithms, and operations, other embodiments could include other modules, algorithms, and/or other operations. Also, while the framework 500 is described as being implemented in the mobile device 202, one or more of the components of the framework 500 could be implemented in one or more of the acoustic devices 204a-204n.

Note that the operations and functions shown in or described with respect to FIGS. 2 through 8 can be implemented in an electronic device 101, server 106, mobile device 202, acoustic device(s) 204a-204n, or other device(s) in any suitable manner. For example, in some embodiments, the operations and functions shown in or described with respect to FIGS. 2 through 8 can be implemented or supported using one or more software applications or other software instructions that are executed by the processor 120 of the electronic device 101, server 106, mobile device 202, acoustic device(s) 204a-204n, or other device(s). In other embodiments, at least some of the operations and functions shown in or described with respect to FIGS. 2 through 8 can be implemented or supported using dedicated hardware components. In general, the operations and functions shown in or described with respect to FIGS. 2 through 8 can be performed using any suitable hardware or any suitable combination of hardware and software/firmware instructions.

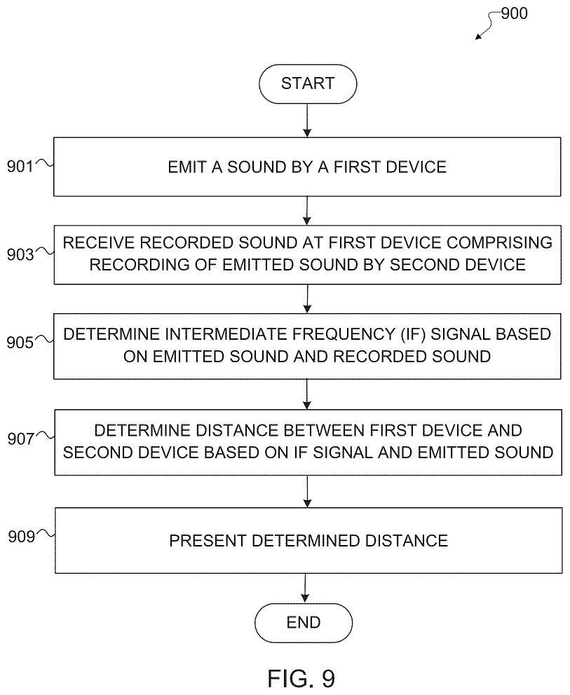

FIG. 9 illustrates an example method 900 for measuring proximity between devices using acoustics according to this disclosure. For ease of explanation, the method 900 shown in FIG. 9 is described as involving the use of the system 200 shown in FIGS. 2 and 3 and the framework 500 shown in FIG. 5. However, the method 900 shown in FIG. 9 could be used with any other suitable framework(s) and device(s) and in any other suitable system(s).

As shown in FIG. 9, a sound is emitted by a first device at step 901. This could include, for example, the mobile device 202 emitting a sound, such as the played sound 601. A recorded sound is received at the first device at step 903. The recorded sound includes a recording of the emitted sound by a second device. This could include, for example, the mobile device 202 receiving a recorded sound, such as the Rx sound 602, where the recorded sound is recorded by one or more of the acoustic devices 204a-204n and transmitted as sound data to the mobile device 202 via the RF module 206.

An IF signal is determined based on the emitted sound and the recorded sound at step 905. This could include, for example, the mobile device 202 determining the IF signal 603 based on the played sound 601 and the Rx sound 602. A distance between the first device and the second device is determined based on a frequency of the IF signal and one or more characteristics of the emitted sound at step 907. This could include, for example, the mobile device 202 determining a distance between the mobile device 202 and one or more of the acoustic devices 204a-204n based on a frequency of the IF signal 603 and the duration and/or bandwidth of the FMCW chirps in the played sound 601. The determined distance is presented at step 909. This could include, for example, the mobile device 202 presenting the determined distance on a display of the mobile device 202.

Although FIG. 9 illustrates one example of a method 900 for measuring proximity between devices using acoustics, various changes may be made to FIG. 9. For example, while shown as a series of steps, various steps in FIG. 9 could overlap, occur in parallel, occur in a different order, or occur any number of times.

Note that the various embodiments of this disclosure can be applied in a variety of use cases and achieve high accuracy. For example, experimental results show that the measurement error in some embodiments is less than 5 mm for a measured distance of 1 m and less than 2 cm for a measured distance of 5 m. Note, however, that these values are for illustration only and can vary depending on the implementation. Also, some embodiments can be used to measure the distance between two devices, and an alert can be generated when the distance is too small (such as less than a threshold distance). This can be useful for social distancing in order to encourage devices (and thus users) to stay apart. The opposite determination can also be useful. For instance, in some embodiments, an alert can be generated when the distance is too large (such as greater than a threshold distance). This may be useful in various scenarios, such as when a smartphone is moving away from a connected smart watch and an alert can be generated notifying the user (so the user does not forget the smart watch). In particular embodiments, when the watch is moving away from the phone (or vice versa), the phone or watch can automatically lock itself. In addition, in some embodiments, a device can build a profile of nearby devices to provide richer context including distances. For example, a device can derive its location from nearby devices if the distances and the locations of the nearby devices are known.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method comprising:
emitting a sound by a first device;
receiving a recorded sound at the first device, the recorded sound comprising a recording of the emitted sound by a second device;
determining an intermediate frequency (IF) signal based on the emitted sound and the recorded sound;
determining a distance between the first device and the second device based on a frequency of the IF signal and one or more characteristics of the emitted sound; and
presenting the determined distance.

2. The method of claim 1, wherein:
the emitted sound comprises one or more frequency-modulated continuous-wave (FMCW) chirps; and
the one or more characteristics of the emitted sound comprise a duration and a bandwidth of the FMCW chirps.

3. The method of claim 2, further comprising:
determining a signal-to-noise ratio (SNR) of the recorded sound; and
responsive to the SNR being less than a specified threshold, adjusting the duration of the FMCW chirps.

4. The method of claim 2, further comprising:
determining a signal-to-noise ratio (SNR) of the recorded sound; and
responsive to the SNR being less than a specified threshold, adjusting a number of chirps in the FMCW chirps.

5. The method of claim 1, wherein:
the first device is a mobile device; and
the second device is an acoustic device.

6. The method of claim 1, wherein:
the first device communicates with the second device via a radio frequency (RF) module; and
the recorded sound is received at the first device via the RF module.

7. The method of claim 1, further comprising:
receiving a second recorded sound at the first device, the second recorded sound comprising a recording of the emitted sound by a third device;
determining a second IF signal based on the emitted sound and the second recorded sound;
determining a second distance between the first device and the third device based on a frequency of the second IF signal and the one or more characteristics of the emitted sound; and
presenting the determined second distance.

8. An electronic device comprising:
at least one processing device configured to:
control the electronic device to emit a sound;
receive a recorded sound, the recorded sound comprising a recording of the emitted sound by a second device;
determine an intermediate frequency (IF) signal based on the emitted sound and the recorded sound; and
determine a distance between the electronic device and the second device based on a frequency of the IF signal and one or more characteristics of the emitted sound; and
at least one display configured to show the determined distance.

9. The electronic device of claim 8, wherein:
the emitted sound comprises one or more frequency-modulated continuous-wave (FMCW) chirps; and
the one or more characteristics of the emitted sound comprise a duration and a bandwidth of the FMCW chirps.

10. The electronic device of claim 9, wherein the at least one processing device is further configured to:
determine a signal-to-noise ratio (SNR) of the recorded sound; and
responsive to the SNR being less than a specified threshold, adjust the duration of the FMCW chirps.

11. The electronic device of claim 9, wherein the at least one processing device is further configured to:
determine a signal-to-noise ratio (SNR) of the recorded sound; and
responsive to the SNR being less than a specified threshold, adjust a number of chirps in the FMCW chirps.

12. The electronic device of claim 8, wherein:
the electronic device is a mobile device; and
the second device is an acoustic device.

13. The electronic device of claim 8, wherein:
the electronic device is configured to communicate with the second device via a radio frequency (RF) module; and
the at least one processing device is configured to receive the recorded sound via the RF module.

14. The electronic device of claim 8, wherein:
the at least one processing device is further configured to:
receive a second recorded sound, the second recorded sound comprising a recording of the emitted sound by a third device;
determine a second IF signal based on the emitted sound and the second recorded sound; and
determine a second distance between the electronic device and the third device based on a frequency of the second IF signal and the one or more characteristics of the emitted sound; and
the at least one display is further configured to show the determined second distance.

15. A non-transitory machine-readable medium containing instructions that when executed cause at least one processor of an electronic device to:
control the electronic device to emit a sound;
receive a recorded sound, the recorded sound comprising a recording of the emitted sound by a second device;
determine an intermediate frequency (IF) signal based on the emitted sound and the recorded sound;
determine a distance between the electronic device and the second device based on a frequency of the IF signal and one or more characteristics of the emitted sound; and
control at least one display to show the determined distance.

16. The non-transitory machine-readable medium of claim 15, wherein:
the emitted sound comprises one or more frequency-modulated continuous-wave (FMCW) chirps; and
the one or more characteristics of the emitted sound comprise a duration and a bandwidth of the FMCW chirps.

17. The non-transitory machine-readable medium of claim 16, wherein the instructions when executed further cause the at least one processor to:
determine a signal-to-noise ratio (SNR) of the recorded sound; and
responsive to the SNR being less than a specified threshold, adjust the duration of the FMCW chirps.

18. The non-transitory machine-readable medium of claim 16, wherein the instructions when executed further cause the at least one processor to:
determine a signal-to-noise ratio (SNR) of the recorded sound; and
responsive to the SNR being less than a specified threshold, adjust a number of chirps in the FMCW chirps.

19. The non-transitory machine-readable medium of claim 15, wherein:
the electronic device is a mobile device; and
the second device is an acoustic device.

20. The non-transitory machine-readable medium of claim 15, wherein:
the electronic device is configured to communicate with the second device via a radio frequency (RF) module; and
the instructions when executed further cause the at least one processor to receive the recorded sound via the RF module.
